(19) United States
(12) Patent Application Publication
(10) Pub. No.: US 2011/0006214 A1
(43) Pub. Date: Jan. 13, 2011

(54) ACCELERATOR SYSTEM AND METHOD FOR SETTING PARTICLE ENERGY

(76) Inventor: MARC-OLIVER BÖNIG, Nurnberg (DE)

Correspondence Address: BRINKS HOFER GILSON & LIONE, P.O. BOX 10395, CHICAGO, IL, 60610, US

(21) Appl. No.: 12/824,919

(22) Filed: Jun. 28, 2010

(30) Foreign Application Priority Data
Jul. 8, 2009 (DE) 10 2009 032 275.2

(51) Int. Cl. G21K 1/08

(52) U.S. Cl. 250/396 R

(57) ABSTRACT

An accelerator system includes an accelerator unit for accelerating particles and a beam transport section that guides the particles from the accelerator unit to a location that is remote from the accelerator unit. An RF cavity generates an electromagnetic RF field that interacts with the particles guided in the beam transport section is disposed along the beam transport section. A phase and a frequency of the RF field are set such that a variation in the energy of the particles interacting with the RF field is generated.

This application claims the benefit of DE 10 2009 032 275.2 filed Jul. 8, 2009, which is hereby incorporated by reference.

### BACKGROUND

The present embodiments relate to an accelerator system that accelerates charged particles and a method for setting the energy of the charged particles.

Particle therapy is an established method for treating tissue (e.g., tumorous diseases). Irradiation methods as used in particle therapy are also used in non-therapeutic areas. The non-therapeutic areas include, for example, research activities that are performed on non-living phantoms or bodies in the field of particle therapy and irradiation operations carried out on materials. In these applications, charged particles such as, for example, protons, carbon ions or other types of ions are accelerated to high energies, formed into a particle beam and guided via a high-energy beam transport system to one or more irradiation rooms. In one of the irradiation rooms, the object that is to be irradiated is irradiated with the particle beam.

When a target volume is irradiated, the penetration depth of the particles or the particle beam into the target volume is determined by the energy that the particles possess. An accelerator (e.g., a synchrotron or cyclotron) generates a substantially monoenergetic particle beam. The particle beam is directed onto a target volume, and the quasi-monoenergetic particles deposit energy within a very small localized region along the beam propagation direction (e.g., within the Bragg peak).

The target volume may move; the movement may be caused, for example, by breathing, heartbeat or intestinal peristalsis, or may be selectively induced by phantoms during an irradiation session. Due to the movement, the penetration depth of the particles may no longer coincide with the desired site of the interaction of the particles with the target volume.

It is well-known to vary the energy of the particles following the acceleration with the aid of a wedge system (e.g., a wedge system made of polymethyl methacrylate). In the wedge system, the particle beam loses energy according to the location at which the beam penetrates the wedge, such that the penetration depth is reduced. The wedge is driven into the beam according to the desired penetration depth. The wedge system is known, for example, from U.S. Pat. No. 6,710,362 B2.

WO 2009/026997 A1 discloses another system for varying the energy of the particle beam using a stationary wedge.

### SUMMARY AND DESCRIPTION

The present embodiments may obviate one or more of the drawbacks or limitations in the related art. For example, in one embodiment, an accelerator system that quickly and accurately sets the energy of a particle beam with high beam quality is provided. In another embodiment, a method for setting the energy of the particle beam quickly and precisely while maintaining a high beam quality is provided.

The above and following statements relating to features, mode of operation and advantages refer in each case to both the system and method (without this being explicitly mentioned each time). The individual features disclosed may also apply to the present embodiments in combinations other than those illustrated.

The accelerator system according to the present embodiments includes: an accelerator unit for accelerating particles to, for example, an energy level for irradiating a target volume; and a beam transport section that follows on from the accelerator unit and may guide the particles that have been accelerated by and extracted from the accelerator unit, to a location that is remote from the accelerator unit (e.g., an irradiation room). An RF cavity, which may generate an electromagnetic RF field that interacts with the particles guided in the beam transport section, is disposed along the beam transport section. A phase and a frequency of the RF field may be set to generate a variation in the energy of the particles interacting with the RF field.

In one embodiment, the accelerator unit is configured to accelerate the particles to at least an energy level that corresponds to a penetration depth into a water-equivalent body of at least 15 cm (e.g., a penetration depth of at least 20 cm or at least 25 cm). Using the accelerator unit, particles may be accelerated, for example, to in excess of 50 MeV. Typical energies used during an irradiation session lie in the range of 48 MeV/u to 250 MeV/u and more for protons, and in the range of 85 MeV/u to 430 MeV/u and more for carbon ions. For this purpose, the accelerator unit may include a circular accelerator such as, for example, a synchrotron or cyclotron.

The particles are directed out of or extracted from the accelerator unit and subsequently guided to an irradiation room. This is effected by using a beam transport system that may have a vacuum tube and a plurality of dipole and quadrupole magnets for deflecting the beam and for focusing and/or defocusing the beam. In conventional accelerator systems, no further change in the energy of the particles generally takes place in the beam transport system.

In one embodiment, an additional RF cavity is disposed along the beam transport system. The additional RF cavity may be used for further acceleration or deceleration of the particles traversing the RF cavity. The further acceleration or deceleration happens via the electromagnetic RF field that is generated by the RF cavity and radiated onto the particles. The frequency of the electromagnetic RF field is tuned to the bunch frequency of the particles.

The electromagnetic RF field that is radiated onto the particles by the RF cavity is tuned to the time instants at which a packet of particles (e.g., a particle bunch) traverses the RF cavity in each case. The phase of the RF field may be tuned to the particle bunches traversing the RF cavity such that, depending on the setting, the particle bunches are accelerated, decelerated or not affected.

In one embodiment, the accelerator system is configured as a particle therapy system, where the accelerator system includes a control device configured for loading an irradiation planning data set and for controlling the accelerator system as a function of the loaded irradiation planning data set. The irradiation planning data set includes control parameters that permit an irradiation of the target volume in accordance with previously defined specifications.

In one embodiment, the irradiation planning data set may include at least one parameter that characterizes a particle energy that is to be set. The control device is configured such that the particle energy may be set using a combination of the activation of the accelerator unit and of the RF cavity. The particle energy that is to be set may be generated, for example, in that the accelerator unit accelerates the particles to a first energy level that may be different from the particle energy, and the RF cavity subsequently compensates for the difference between the first energy level and the particle energy that is to be provided.

In this way, the energy of the particle beam, for example, may be set quickly and easily. If in the case of a layer-by-layer irradiation, for example, the energy of the particle beam is varied to adjust the particle beam from one layer to the next layer, the energy of the particle beam is modified. This is comparatively time consuming if the energy of the particle beam is set in the accelerator unit in each case, as the magnets are reset and checked in each case when using a synchrotron, for example.

With the aid of the RF cavity, however, the energy of the particle beam may be varied quickly and easily within certain limits without modifying the accelerator unit. The activation of the RF cavity and consequently, the change in the energy of the particle beam, may be performed very quickly by comparison to modifying the accelerator unit. Only if the energy of the particle beam is to be modified to a degree that exceeds the capacity of the RF cavity, is the setting of the accelerator unit changed.

In one embodiment, the accelerator system includes a device that detects the position of a target volume that is to be irradiated. For example, the accelerator system may include an interface that may register the signals of a respiration sensor. Inferences about the respiratory movement may be made from the signals of the respiration sensor. From the inferences about the respiratory movement, the position of a target volume that is shifted as a result of the respiratory movement may be determined. The device that detects the position of the target volume that is to be irradiated may consequently also register a signal that permits an indirect inference to be made about the position of the target volume. The respiration sensor is described by way of example; X-ray devices or other known devices may be used to monitor the position of the target volume.

The control device may vary the energy of the particles accordingly as a function of the position of the target volume that is to be irradiated. The control device may vary the energy of the particles by activating the RF cavity in order, for example, to quickly adjust the energy of the particles to match the tissue that lies in the beam propagation direction upstream of the target volume and is to be traversed. The variation is possible because the activation of the RF cavity is very fast, with the result that the particle beam may be adjusted to track the movement of the target volume. In one embodiment, the phase of the RF field may be varied continuously in order to achieve a variable change in the penetration depth of the particle beam.

Compared to depth modulation devices that have a material that may be introduced into the particle beam, the embodiment described above has the advantage that the quality of the particle beam is not adversely affected by the material through which the particle beam is guided. The patient is exposed to a lower dose of radiation because the spallation or scattering of the primary beam in matter is avoided. This prevents damage to tissue that is not to be exposed to radiation. The particle beam widens out to a lesser degree, and thus, a smaller beam spot overall may be achieved in the isocenter, resulting in a better beam quality and a more precise irradiation of the target volume.

In one embodiment, the RF cavity is superconducting in order to occupy less space.

The RF cavity is dimensioned such that an energy modulation of the particle beam entering the RF cavity is achieved. In one embodiment, the energy modulation of the particle beam corresponds to a modulation of the penetration depth of the particles in a water-equivalent body of at least 1 cm (e.g., a penetration depth of at least 2 cm, at least 3 cm or more). Typical movements of a target volume in the case of a particle therapy system may be mapped.

In one embodiment, the RF cavity is configured such that the RF field that may be generated amounts to a maximum field strength of at least 20 MV/m. In another embodiment, the maximum field strength amounts to at least 40 MV/m or 50 MV/m. In one embodiment, variations in the beam energy amounting to as much as 50 MeV may be achieved, and hence, in the case of protons, a change in the penetration depth of 2 cm to 3 cm water equivalence may be generated. Such field strengths and changes in the energy of the particles may be achieved using an RF cavity having a length of 1 m to 2 m, for example. RF cavities dimensioned in this way may be installed without difficulty in a beam transport section, without significantly converting or modifying a conventional beam transport section.

In one embodiment, a method for setting the energy of particles that are accelerated in an accelerator system is provided. The method includes accelerating the particles to a first energy level using an accelerator unit and guiding the accelerated particles from the accelerator unit to an irradiation room. The particles are guided along a section from the accelerator unit to the irradiation room, through an RF cavity in which an RF field acts on the particles. A phase and a frequency of the RF field are controlled such that the energy of the particles passing through the RF cavity is modified.

The combination of acceleration to a first energy level and subsequent modification of the energy may be controlled in such a way that after exiting the RF cavity, the particles have a predefined energy stored in an irradiation planning data set, for example.

In one embodiment, the energy of the particles accelerated to the first energy level may be variably modified, for example, by continuously varying the phase of the field acting on the particles.

The method may be used to modify the particles accelerated to the first energy level as a function of a movement of a target volume that is to be irradiated. The particle beam may be adjusted to track a movement of the target volume.

### BRIEF DESCRIPTION OF THE DRAWINGS

FIG. 1 shows a schematic view of the layout of one embodiment of a particle therapy system;

FIG. 2 shows an example diagram of the interaction of the RF field generated by the RF cavity with particle bunches; and

FIG. 3 shows a diagram of one embodiment of a method for setting the energy of particles that are accelerated in an accelerator system.

### DETAILED DESCRIPTION OF THE DRAWINGS

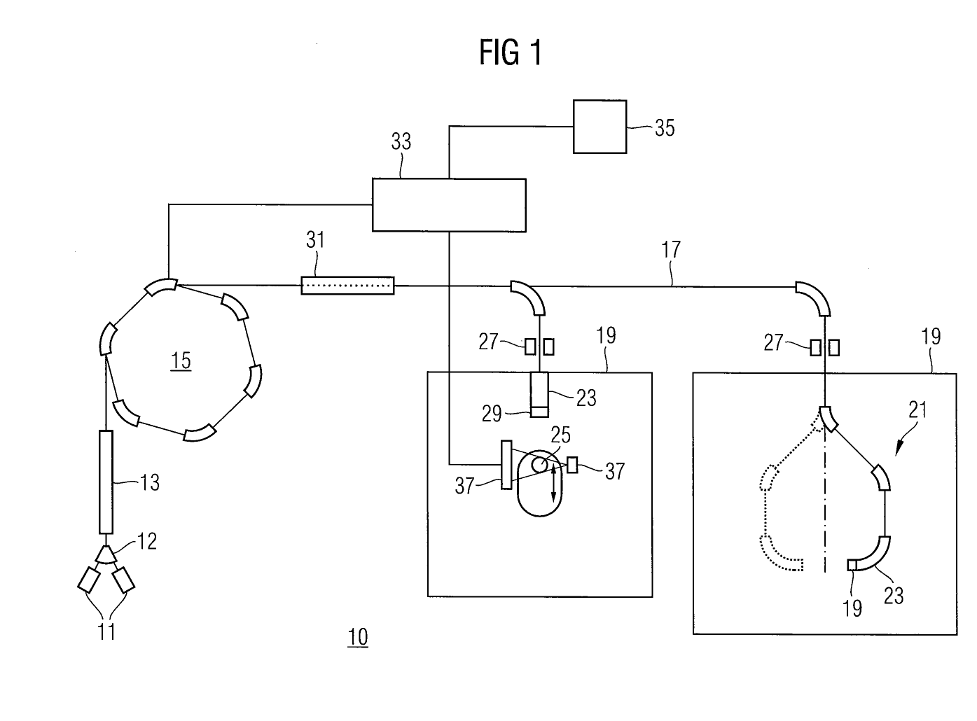

FIG. 1 shows a schematic view (not true to scale) of the layout of a particle therapy system 10. In the particle therapy system 10, a body (e.g., a tumor-diseased tissue) is irradiated using a particle beam. Phantoms or cell cultures may also be irradiated, for example, for research or for maintenance purposes.

Ions such as, for example, protons, pions, helium ions, carbon ions or other types of ions may be used as particles. The particles may be generated in a particle source 11 (e.g., ion source 11). If, as shown in FIG. 1, two particle sources 11 are used to generate two different types of ions, the two types of ions may be switched between within a short time interval. A switching magnet 12 that is disposed between the ion sources 11 and a preaccelerator 13 may be used to switch between the two types of ions. In one embodiment, the particle therapy system 10 may be operated with protons and carbon ions simultaneously using the switching magnet 12.

The ions generated by one of the ion sources 11 and selected using the switching magnet 12 are accelerated in the preaccelerator 13 to a first energy level. The preaccelerator 13 is, for example, a linear accelerator (LINAC). The particles are fed into an accelerator 15 (e.g., a synchrotron or cyclotron). In the accelerator 15, the particles are accelerated to high energies for irradiation purposes.

After the particles leave the accelerator 15, a high-energy beam transport system 17 guides the particle beam to one or more irradiation rooms 19. In an irradiation room 19, the accelerated particles are directed onto a body that is to be irradiated. In one embodiment, the accelerated particles are directed onto the body to be irradiated from a fixed direction (e.g., in “fixed beam” rooms). In another embodiment, the accelerated particles are directed onto the body to be irradiated from different directions via a rotatable gantry 21 that is movable about an axis.

In the irradiation room 19, the particle beam emerges from a beam outlet 23 and strikes a target volume 25 that is to be irradiated. In one embodiment, the target volume 25 may be located in the isocenter of the irradiation room 19.

The particle therapy system 10 may also include a system of scanning magnets 27 (e.g., deflection magnets 27), which may be used to deflect and scan the particle beam across the target volume 25, and a monitor system 29, which may be used to monitor various particle beam parameters.

An RF cavity 31 is integrated into the high-energy beam transport system 17. The RF cavity 31 enables an RF field to act on the particle beam when particle bunches of the particle beam traverse the RF cavity 31. In terms of a principle and mode of operation, the RF cavity 31 is similar to an RF cavity as used in a synchrotron for accelerating particle bunches circulating in the synchrotron.

FIG. 1 shows the RF cavity 31 disposed in the beam transport section upstream of the deflection magnets 27, which are used to divert the particle beam to the individual irradiation rooms 19. Although this has the advantage that the RF cavity 31 may be used jointly by all the irradiation rooms 19, thereby making the system cost-effective, a disadvantageous aspect with an embodiment of this type is that the magnetic field of the following deflection magnets 27 must also be adapted to the change in energy generated using the RF cavity 31. Under certain conditions, this may limit the speed at which an energy modification may be controlled or regulated.

In one embodiment (not shown here for clarity of illustration reasons), the RF cavity 31 may also be disposed along the beam transport section downstream of the deflection magnet 27 that directs the particle beam into one of the irradiation rooms 19. A faster variation of the energy of the particles may be generated using the RF cavity 31, since fewer or no following magnets are adapted to the energy change generated using the RF cavity 31. This is advantageous, in particular, during the tracking of a movement of the target volume 25. An RF cavity 31 of the type described above is provided for each irradiation room 19 to change the energy of the particles.

The frequency with which the particle bunches traverse the RF cavity 31 depends partly on the energy level at which the particles are accelerated using the accelerator 15. The frequency of the RF field is tuned to the frequency of the particle bunches.

The phase of the RF field is tuned to the time instants at which the particle bunches traverse the RF cavity 31 such that the energy of the particle bunches is increased, lowered or left the same.

In order to achieve this, the particle therapy system 10 includes a control device 33, into which an irradiation planning data set 35, for example, may be loaded in order to control the particle therapy system 10 so as to implement the associated irradiation plan. The control device 33 controls the components of the particle therapy system 10 as appropriate (e.g., the accelerator 15 and the RF cavity 31) and accordingly, is connected to the components to be controlled (for clarity of illustration, only a few connections are shown).

A movement monitoring device 37 (e.g., a fluoroscopy device) may also be provided in the irradiation room 19 to track the movement of the target volume 25. The data recorded by the movement monitoring device 37 is transmitted via an interface of the control device 33, which based on the recorded data, determines the energy variation for adjusting the particle beam in order to track the movement of the target volume 25. The RF cavity 31 is controlled accordingly.

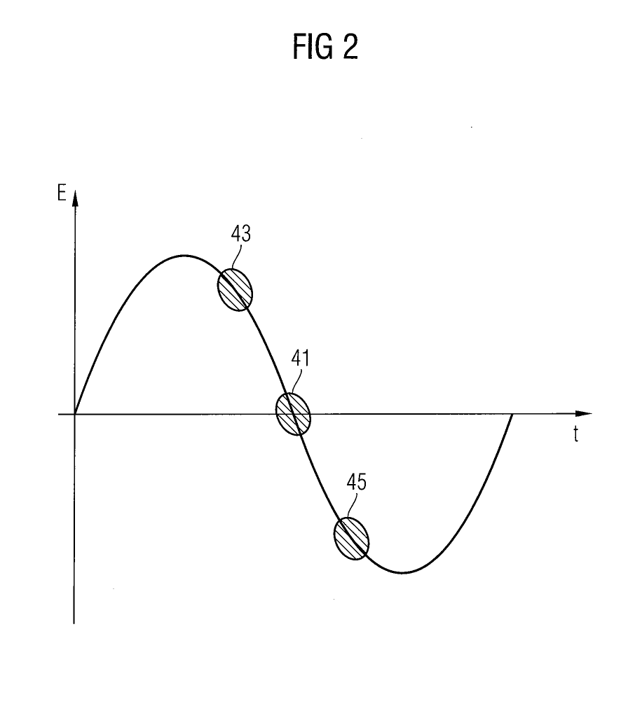

FIG. 2 shows a diagram of the tuning of the phase of the RF field to the particle bunches on which the RF field acts.

The diagram shows the change over time of the electric field E radiated by the RF cavity 31. If the electric field E is at the zero crossing at the time instant at which a particle bunch passes through the RF cavity, the energy of the particle bunch is not changed (point 41). If, however, the phase of the electric field E is shifted in one direction (point 43), an acceleration of the particle bunch takes place. If the phase of the electric field E is shifted in the other direction (point 45), the particle bunch is decelerated. In order to switch back and forth between the individual points, the phase may be continuously shifted between the particle bunches and the RF wave. In this way, a continuous variation of the beam energy is achieved within certain limits.

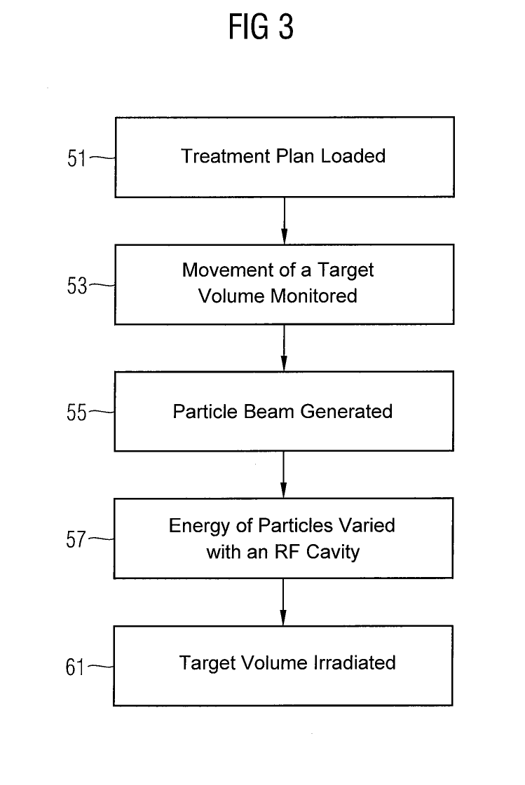

FIG. 3 shows a diagram of one embodiment of a method for setting the energy of particles that are accelerated in an accelerator system.

In act 51, an irradiation planning data set is loaded into a control device of a particle therapy system. Data of an irradiation plan specifying how an irradiation of a target volume is to take place in order to deposit a desired nominal dose distribution in the target volume is stored in the irradiation planning data set.

The movement of the target volume starts to be monitored and registered in act 53.

A particle beam that is suitable for implementing the irradiation planning data set is generated. The particles are initially accelerated to a first energy level in an accelerator unit at act 55. The energy of the particles is varied with the aid of an RF cavity at act 57. The accelerator unit and the RF cavity are controlled in accordance with the specifications stored in the irradiation planning data set and the registered movement position of the target volume.

At act 59, the target volume is irradiated using the particle beam having energy that has been set with the aid of the accelerator unit and the RF cavity.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An accelerator system comprising:
an accelerator unit for accelerating particles; and
a beam transport section that follows on from the accelerator unit and guides particles that are accelerated by and have been extracted from the accelerator unit, from the accelerator unit to a location that is remote from the accelerator unit,
wherein an RF cavity that generates an electromagnetic RF field that interacts with the particles guided in the beam transport section is disposed along the beam transport section, and
wherein a phase and a frequency of the electromagnetic RF field are set such that a variation in the energy of the particles interacting with the RF field is generated.

2. The accelerator system as claimed in claim 1, wherein the accelerator system is a particle therapy system, the accelerator system comprising a control device that is configured for:
loading an irradiation planning data set; and
controlling the accelerator system as a function of the loaded irradiation planning data set.

3. The accelerator system as claimed in claim 2, wherein the irradiation planning data set comprises a parameter that characterizes a particle energy that is to be set, and
wherein the control device is configured for setting the particle energy by activating the accelerator unit and the RF cavity such that the accelerator unit accelerates the particles to a first energy level, which is subsequently modified using the RF cavity such that the particle energy stored in the irradiation planning data set is set.

4. The accelerator system as claimed in claim 2, further comprising a device for detecting a position of a target volume that is to be irradiated,
wherein the control device is configured for activating the RF cavity as a function of the position of the target volume that is to be irradiated.

5. The accelerator system as claimed in claim 1, wherein the RF cavity is superconducting.

6. The accelerator system as claimed in claim 1, wherein the RF cavity is dimensioned such that the RF cavity is operable to generate an RF field having a field strength of at least 20 MV/m.

7. The accelerator system as claimed in claim 1, wherein the RF cavity extends over a length in the beam propagation direction of at least 1 m.

8. The accelerator system as claimed in claim 1, wherein the RF cavity is dimensioned such that an energy modulation of the particle beam traversing the RF cavity is achieved using the RF cavity, and
wherein the energy modulation of the particle beam corresponds to a modulation of the penetration depth into a water-equivalent body of at least 1 cm.

9. The accelerator system as claimed in claim 1, wherein the particles are accelerated, using the accelerator unit, to an energy that corresponds to a penetration depth into a water-equivalent body of at least 15 cm.

10. A method for setting the energy of particles that are accelerated in an accelerator system, the method comprising:
accelerating the particles to a first energy level using an accelerator unit; and
guiding the accelerated particles from the accelerator unit to an irradiation room,
wherein guiding the accelerated particles from the accelerator unit to the irradiation room comprises guiding the accelerated particles through an RF cavity, in which an RF field acts on the particles, and
wherein a phase and a frequency of the RF field are set such that the energy of the particles passing through the RF cavity is modified.

11. The method as claimed in claim 10, wherein a predefined energy is set for the particles in that the particles are initially accelerated to the first energy level, and the energy of the particles accelerated to the first energy level is modified with the aid of the RF cavity to set the predefined energy.

12. The method as claimed in claim 10, wherein the energy of the particles accelerated to the first energy level is variably modified through variation of the phase of the RF field acting on the particles.

13. The method as claimed in claim 10, wherein the energy of the particles accelerated to the first energy level is modified as a function of a movement of a target volume that is to be irradiated.

14. The method as claimed in claim 11, wherein the energy of the particles accelerated to the first energy level is variably modified through variation of the phase of the RF field acting on the particles.

15. The method as claimed in claim 11, wherein the energy of the particles accelerated to the first energy level is modified as a function of a movement of a target volume that is to be irradiated.

16. The method as claimed in claim 12, wherein the energy of the particles accelerated to the first energy level is modified as a function of a movement of a target volume that is to be irradiated.

17. The accelerator system as claimed in claim 2, wherein the RF cavity is dimensioned such that the RF cavity is operable to generate an RF field having a field strength of at least 20 MV/m.

18. The accelerator system as claimed in claim 2, wherein the RF cavity is dimensioned such that an energy modulation of the particle beam traversing the RF cavity is achieved using the RF cavity, and
wherein the energy modulation of the particle beam corresponds to a modulation of the penetration depth into a water-equivalent body of at least 1 cm.

19. The accelerator system as claimed in claim 3, further comprising a device for detecting a position of a target volume that is to be irradiated,
wherein the control device is configured for activating the RF cavity as a function of the position of the target volume that is to be irradiated.

20. The accelerator system as claimed in claim 6, wherein the RF cavity extends over a length in the beam propagation direction of at least 1 m.
